(19) United States
(12) Patent Application Publication
(10) Pub. No.: US 2026/0342483 A1
(43) Pub. Date: Oct. 29, 2026

(54) METHOD AND APPARATUS FOR PSFCH RESOURCE DETERMINATION OVER UNLICENSED SPECTRUM

(71) Applicant: Lenovo (Beijing) Limited, Beijing (CN)

(72) Inventors: Haipeng LEI, Beijing (CN); Xin GUO, Beijing (CN); Xiaodong YU, Beijing (CN); Zhennian SUN, Beijing (CN)

(21) Appl. No.: 19/099,673

(22) PCT Filed: Aug. 1, 2022
(86) PCT No.: PCT/CN2022/109454

§ 371 Date: Jan. 29, 2025

(51) Int. Cl. H04L 1/1812; H04L 5/00; H04L 27/26; H04W 72/0446; H04W 72/0453; H04W 72/25

(52) U.S. Cl. CPC H04L 1/1812; H04L 5/0053; H04L 27/2605; H04W 72/0446; H04W 72/0453; H04W 72/25

(57) ABSTRACT

Embodiments of the present disclosure relate to methods and apparatuses for PSFCH resource determination over an unlicensed spectrum. According to some embodiments of the disclosure, a UE may: determine a HARQ-ACK feedback window comprising a plurality of slots, wherein HARQ-ACK feedback for PSSCHs transmitted in the HARQ-ACK feedback window is to be transmitted in the same PSFCH occasion; transmit a first PSSCH in a first slot of the plurality of slots on a set of interlaces of a carrier, wherein the carrier may include a plurality of interlaces including the set of interlaces, and each of the plurality of interlaces may include a plurality of RBs equally spaced in a frequency domain; determine, based on the set of interlaces and the first slot, a first PSFCH resource corresponding to the first PSSCH in the PSFCH occasion; and receive HARQ-ACK feedback for the first PSSCH on the first PSFCH resource in the PSFCH occasion.

### TECHNICAL FIELD

Embodiments of the present disclosure generally relate to wireless communication technology, and more particularly to physical sidelink feedback channel (PSFCH) resource determination over an unlicensed spectrum.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Some wireless communication systems may support sidelink communications, in which devices (e.g., UEs) that are relatively close to each other may communicate with one another directly via a sidelink, rather than being linked through the BS. The term “sidelink” may refer to a radio link established for communicating among devices (e.g., UEs), as opposed to communicating via the cellular infrastructure (e.g., uplink and downlink). Sidelink transmission may be performed on a licensed spectrum and/or an unlicensed spectrum.

There is a need for handling sidelink transmissions on an unlicensed spectrum.

### SUMMARY

Some embodiments of the present disclosure provide a first user equipment (UE). The first UE may include a transceiver, and a processor coupled to the transceiver. The processor may be configured to: determine a hybrid automatic repeat request acknowledgement (HARQ-ACK) feedback window comprising a plurality of slots, wherein HARQ-ACK feedback for physical sidelink shared channels (PSSCHs) transmitted in the HARQ-ACK feedback window is to be transmitted in the same physical sidelink feedback channel (PSFCH) occasion; transmit a first PSSCH in a first slot of the plurality of slots on a set of interlaces of a carrier, wherein the carrier comprises a plurality of interlaces including the set of interlaces, and each of the plurality of interlaces comprises a plurality of resource blocks (RBs) equally spaced in a frequency domain; determine, based on the set of interlaces and the first slot, a first PSFCH resource corresponding to the first PSSCH in the PSFCH occasion; and receive HARQ-ACK feedback for the first PSSCH on the first PSFCH resource in the PSFCH occasion.

In some embodiments of the present disclosure, the number of the plurality of slots may be smaller than or equal to the number of supported cyclic shift (CS) pairs.

Some embodiments of the present disclosure provide a second user equipment (UE). The second UE may include a transceiver, and a processor coupled to the transceiver. The processor may be configured to: receive a first physical sidelink shared channel (PSSCH) in a first slot on a set of interlaces of a carrier, wherein the carrier comprises a plurality of interlaces including the set of interlaces, and each of the plurality of interlaces comprises a plurality of resource blocks (RBs) equally spaced in a frequency domain; determine a hybrid automatic repeat request acknowledgement (HARQ-ACK) feedback window comprising a plurality of slots, wherein the plurality of slots comprises the first slot, and wherein HARQ-ACK feedback for PSSCHs transmitted in the HARQ-ACK feedback window is to be transmitted in the same physical sidelink feedback channel (PSFCH) occasion; determine, based on the set of interlaces and the first slot, a first PSFCH resource corresponding to the first PSSCH in the PSFCH occasion; and transmit HARQ-ACK feedback for the first PSSCH on the first PSFCH resource in the PSFCH occasion.

In some embodiments of the present disclosure, the number of the plurality of slots may be smaller than or equal to the number of supported cyclic shift (CS) pairs.

Some embodiments of the present disclosure provide a method for wireless communication performed by a first UE. The method may include: determining a hybrid automatic repeat request acknowledgement (HARQ-ACK) feedback window comprising a plurality of slots, wherein HARQ-ACK feedback for physical sidelink shared channels (PSSCHs) transmitted in the HARQ-ACK feedback window is to be transmitted in the same physical sidelink feedback channel (PSFCH) occasion; transmitting a first PSSCH in a first slot of the plurality of slots on a set of interlaces of a carrier, wherein the carrier comprises a plurality of interlaces including the set of interlaces, and each of the plurality of interlaces comprises a plurality of resource blocks (RBs) equally spaced in a frequency domain; determining, based on the set of interlaces and the first slot, a first PSFCH resource corresponding to the first PSSCH in the PSFCH occasion; and receiving HARQ-ACK feedback for the first PSSCH on the first PSFCH resource in the PSFCH occasion.

Some embodiments of the present disclosure provide a method for wireless communication performed by a second UE. The method may include: receiving a first physical sidelink shared channel (PSSCH) in a first slot on a set of interlaces of a carrier, wherein the carrier comprises a plurality of interlaces including the set of interlaces, and each of the plurality of interlaces comprises a plurality of resource blocks (RBs) equally spaced in a frequency domain; determining a hybrid automatic repeat request acknowledgement (HARQ-ACK) feedback window comprising a plurality of slots, wherein the plurality of slots comprises the first slot, and wherein HARQ-ACK feedback for PSSCHs transmitted in the HARQ-ACK feedback window is to be transmitted in the same physical sidelink feedback channel (PSFCH) occasion; determining, based on the set of interlaces and the first slot, a first PSFCH resource corresponding to the first PSSCH in the PSFCH occasion; and transmitting HARQ-ACK feedback for the first PSSCH on the first PSFCH resource in the PSFCH occasion.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates an example of an interlace-based resource block configuration according to some embodiments of the present disclosure;

FIGS. 3-5 illustrate examples of HARQ-ACK feedback windows according to some embodiments of the present disclosure;

FIGS. 6-8 illustrate examples of PSFCH resource mapping according to some embodiments of the present disclosure;

FIGS. 9 and 10 illustrate flow charts of exemplary procedures of sidelink communications in accordance with some embodiments of the present disclosure; and

FIG. 11 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

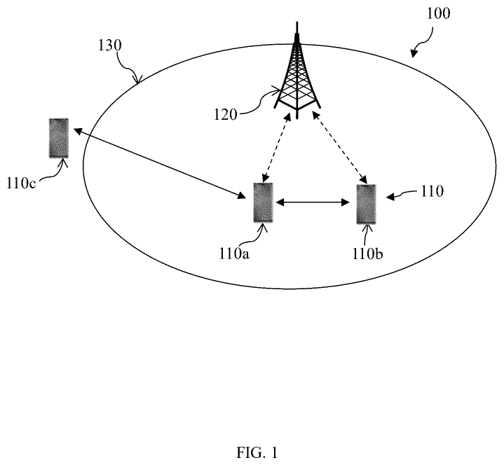

FIG. 1 illustrates a schematic diagram of a wireless communication system 100 in accordance with some embodiments of the present disclosure.

As shown in FIG. 1, wireless communication system 100 may include a base station (e.g., BS 120) and some UEs 110 (e.g., UE 110a, UE 110b, and UE 110c). Although a specific number of UEs 110 and one BS 120 are depicted in FIG. 1, it is contemplated that any number of BSs and UEs in and outside of the coverage of the BSs may be included in the wireless communication system 100.

In some embodiments of the present disclosure, BS 120 may be referred to as an access point, an access terminal, a base, a base unit, a macro cell, a Node-B, an evolved Node B (eNB), a gNB, a Home Node-B, a relay node, or a device, or described using other terminology used in the art. BS 120 is generally a part of a radio access network that may include one or more controllers communicably coupled to one or more corresponding BSs. BS 120 may communicate with UE(s) 110 via downlink (DL) communication signals.

UE(s) 110 (e.g., UE 110a, UE 110b, or UE 110c) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE(s) 110 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE(s) 110 includes wearable devices, such as smart watches, fitness bands, optical head-mounted displays, or the like. Moreover, UE(s) 110 may be referred to as a subscriber unit, a mobile, a mobile station, a user, a terminal, a mobile terminal, a wireless terminal, a fixed terminal, a subscriber station, a user terminal, an IoT device, a vehicle, or a device, or described using other terminology used in the art. UE(s) 110 may communicate with BS 120 via uplink (UL) communication signals.

Wireless communication system 100 may be compatible with any type of network that is capable of sending and receiving wireless communication signals. For example, wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, wireless communication system 100 is compatible with 5G NR of the 3GPP protocol. For example, BS 120 may transmit data using an orthogonal frequency division multiple (OFDM) modulation scheme on the DL and UE(s) 110 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS 120 and UE(s) 110 may communicate using other communication protocols, such as the IEEE 802.11 family of wireless communication protocols. Further, in some embodiments of the present disclosure, BS 120 and UE(s) 110 may communicate over licensed spectrums, whereas in some other embodiments, BS 120 and UE(s) 110 may communicate over unlicensed spectrums. The present disclosure is not intended to be limited to the implementation of any particular wireless communication system architecture or protocol.

BS 120 may define one or more cells, and each cell may have a coverage area 130. In the exemplary wireless communication system 100, some UEs (e.g., UE 110a and UE 110b) are within the coverage of BS 120, which may not be the specific BS 120 as shown in FIG. 1 and can be any one of the BSs 120 in a wireless communication system, and some UEs (e.g., UE 110c) are outside of the coverage of BS 120. For example, in the case that the wireless communication system includes two BSs 120 with UE 110a being within the coverage of any one of the two BSs means that UE 110a is within the coverage of a BS 120 (i.e., in-coverage) in the wireless communication system; and UE 110a being outside of the coverage of both BSs 120 means that UE 110a is outside the coverage of a BS 120 (i.e., out-of-coverage) in the wireless communication system.

Still referring to FIG. 1, UE 110a and UE 110b may communicate with BS 120 via, for example, a Uu link (denoted by dotted arrow in FIG. 1). UE 110a, UE 110b, and UE 110c may communicate with each other via a sidelink (denoted by solid arrow in FIG. 1). In some embodiments, UE 110a, UE 110b, and UE 110c may form a UE group.

Sidelink transmission may involve a physical sidelink control channel (PSCCH) and an associated physical sidelink shared channel (PSSCH), which is scheduled by the sidelink control information (SCI) carried on the PSCCH. The SCI and associated PSSCH may be transmitted from a transmitting UE (hereinafter referred to as “Tx UE”) to a receiving UE (hereinafter referred to as “Rx UE”) in a unicast manner, to a group of Rx UEs in a groupcast manner, or to Rx UEs within a range in a broadcast manner. For example, referring to FIG. 1, UE 110a (acting as a Tx UE) may transmit data to UE 110b or UE 110c (acting as an Rx UE).

The PSSCH may carry data which may require corresponding HARQ-ACK feedback from the Rx UE(s) to the Tx UE. The HARQ-ACK feedback for a PSSCH may be carried on a physical sidelink feedback channel (PSFCH).

In some embodiments of the present disclosure, sidelink transmission may be performed on an unlicensed spectrum. This is advantageous because a sidelink transmission over an unlicensed spectrum can achieve, for example, an increased data rate(s). In order to achieve fair coexistence between various systems, for example, NR systems (e.g., NR-U systems) and other wireless systems, a channel access procedure, also known as a listen-before-talk (LBT) test, may be performed before communicating on the unlicensed spectrum.

To perform the LBT test, energy detection may be performed on a certain channel. If the received power of the channel is below a predefined threshold, the LBT test may be determined as successful, and the channel may then be deemed as empty and available for transmission. Only when the LBT test is successful can a device (e.g., a UE) start transmission on the channel and occupy the channel up to a maximum channel occupancy time (MCOT). Otherwise, that is, if the LBT test fails, the device cannot start any transmission on the channel, and may continue to perform another LBT test until a successful LBT test result.

For a sidelink transmission over an unlicensed spectrum, an interlace-based structure can be adopted for the sidelink channels including, for example, PSCCH, PSSCH and PSFCH, to obey the regulatory requirements. The requirements may include at least one of the following:
occupied channel bandwidth (OCB): the bandwidth containing 99% of the power of the signal, shall be between, for example, 80% and 100% of the declared nominal channel bandwidth; or
maximum power spectrum density (PSD) with a resolution bandwidth of, for example, 1 MHz (e.g., 10 dBm/MHz).

An interlace may be defined as a set of resource blocks (RBs) equally spaced in the frequency domain. For example, multiple interlaces of RBs may be defined in common RBs based on the subcarrier spacing (SCS). The total number of interlaces in the frequency domain may be dependent on only the SCS of a carrier, regardless of concrete carrier bandwidth. For example, for 15 kHz SCS, there may be 10 interlaces on the carrier; and for 30 kHz SCS, there may be 5 interlaces on the carrier.

The number of RBs of each interlace may be dependent on the concrete carrier bandwidth. For example, for a 20 MHz bandwidth with 15 kHz SCS, each of the 10 interlaces may include 10 or 11 RBs; and for a 20 MHz bandwidth with 30 kHz SCS, each of the 5 interlaces may include 10 or 11 RBs. For a carrier bandwidth larger than 20 MHz, the same spacing between consecutive RBs in an interlace may be maintained for all interlaces regardless of the carrier bandwidth. That is, the number of RBs per interlace may be dependent on the carrier bandwidth. Keeping the same interlace spacing with increasing bandwidth is a straightforward and simple way to scale the interlace design from 20 MHz to a wider bandwidth(s). For example, for an 80 MHz bandwidth with 30 kHz SCS, each of the 5 interlaces may include 43 or 44 RBs.

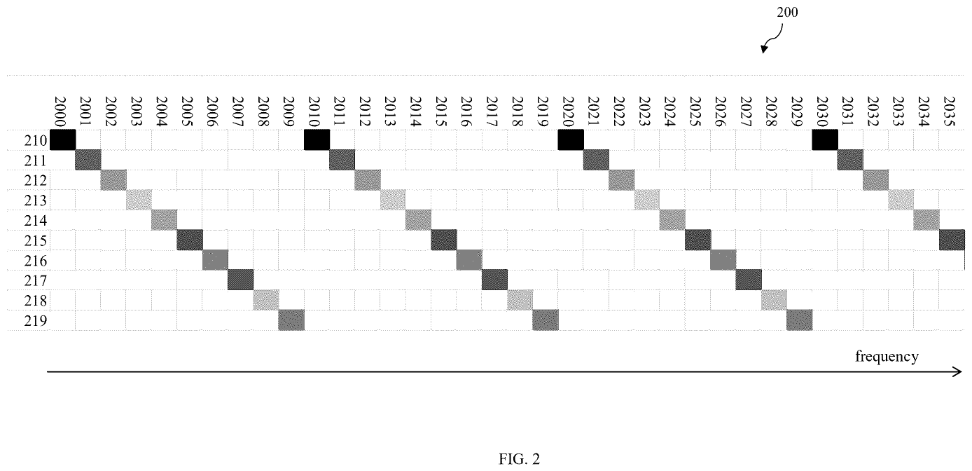

FIG. 2 illustrates an example of interlace-based resource block configuration 200 for 15 kHz SCS according to some embodiments of the present disclosure. It should be understood that configuration 200 is only for illustrative purposes, and should not be construed as limiting the embodiments of the present disclosure.

As shown in FIG. 2, carrier bandwidth may be partitioned into resource blocks (RBs). For illustrative purposes, FIG. 2 only shows a part of the RBs (e.g., RBs that are represented with reference numerals 2000 to 2035 in FIG. 2) included in the carrier bandwidth. Persons skilled in the art can readily know the number of RBs included in a certain carrier bandwidth by referring to bandwidth configurations for different SCSs.

As mentioned above, the number of interlaces distributed within the bandwidth of a carrier may be based on only the SCS regardless of the bandwidth of the carrier. In the example of FIG. 2, the RBs of the carrier bandwidth are partitioned into 10 interlaces (corresponding to 15 kHz SCS), which are represented with reference numerals 210, 211, 212, 213, 214, 215, 216, 217, 218, and 219 in FIG. 2.

Each interlace of the 10 interlaces may include evenly-spaced RBs in the frequency domain. The number of RBs included in each of the 10 interlaces may depend on carrier bandwidth. As shown in FIG. 2, interlace 210 may include RB 2000, RB 2010, RB 2020, RB 2030, and so on; interlace 211 may include RB 2001, RB 2011, RB 2021, RB 2031, and so on; and interlace 219 may include RB 2009, RB 2019, RB 2029, and so on. RB 2000 to RB 2035 may be indexed from “0” to “35” along the frequency axis, and interlaces 210 to 219 may be indexed from “0” to “9”.

As stated above, for a sidelink transmission over an unlicensed spectrum, the interlace-based structure can be adopted for sidelink channels. For example, for a given PSSCH transmission on one or multiple interlaces for unicast purposes, one interlace may be enough for the Rx UE to transmit the corresponding PSFCH. For example, for a given PSSCH transmission for groupcast purposes, in the case of a first type of groupcast (also referred to as “groupcast option 1” or “groupcast NACK only based HARQ-ACK feedback”) being enabled, all the Rx UEs may share one PSFCH resource, and an Rx UE may transmit a negative ACK (NACK) on the PSFCH resource if it does not correctly decode the PSSCH or transmit nothing on the PSFCH resource if it correctly decodes the PSSCH. In this scenario, one interlace would be enough for a group of UEs to transmit corresponding PSFCHs on the same PSFCH resource. In the case of a second type of groupcast (also referred to as “groupcast option 2” or “groupcast ACK or NACK based HARQ-ACK feedback”) being enabled, each of the Rx UEs may have a separate PSFCH resource, and an Rx UE may transmit a NACK on the PSFCH resource if it does not correctly decode the PSSCH, or transmit ACK on the PSFCH resource if it correctly decodes the PSSCH. In this scenario, multiple interlaces may be needed so that each Rx UE can transmit a corresponding PSFCH.

When the interlace-based structure is employed for sidelink transmissions, the unit of the PSFCH resource is an interlace, instead of a RB. However, the number of PSFCH resources is quite limited and dependent on the number of interlaces. For example, for 15 kHz SCS, there may be 10 interlaces; and for 30 kHz SCS, there may be 5 interlaces. Hence, it is desirable to improve PSFCH resource capacity. Moreover, a PSFCH resource mapping procedure is needed for a UE to determine a PSFCH resource and avoid potential PSFCH resource collision.

Embodiments of the present disclosure provide solutions to improve PSFCH capacity and solutions for resource determination for sidelink HARQ-ACK feedback transmissions over an unlicensed spectrum. More details on the embodiments of the present disclosure will be illustrated in the following text in combination with the appended drawings.

In some embodiments of the present disclosure, for a sidelink transmission over an unlicensed spectrum, for a plurality of PSSCHs transmitted in a plurality of slots, a HARQ-ACK feedback window is defined. The HARQ-ACK feedback window may include one or multiple slots with corresponding sidelink HARQ-ACK feedback to be transmitted in the same PSFCH transmission occasion (also referred to as PSFCH occasion). In some examples, a HARQ-ACK feedback window may include, for example, 2, 4, 6, or 8 slots. The indices of slots within a HARQ-ACK feedback window may be redefined with reference to the starting slot of the HARQ-ACK feedback window. The processing delay of a UE may be considered to determine a PSFCH occasion (e.g., the first PSFCH occasion) for a given PSSCH reception.

Various methods may be employed to define the HARQ-ACK feedback window.

For example, in some embodiments of the present disclosure, a HARQ-ACK feedback window may include a number of consecutive slots based on a PSFCH periodicity. For example, the number of slots in a HARQ-ACK feedback window may be equal to the PSFCH periodicity. The PSFCH periodicity may be configured by RRC signaling, predefined in a standard, or preconfigured.

The PSFCH transmission occasion for the HARQ-ACK feedback window may be determined based on a PSFCH configuration. From a UE's perspective, even it does not receive any PSSCH in a certain slot, it may assume the slot is within a HARQ-ACK feedback window. For example, if a hypothetic PSFCH for a hypothetic PSSCH in the slot should be transmitted in the same PSFCH transmission occasion as another slot, the slot and the another slot are within the same HARQ-ACK feedback window.

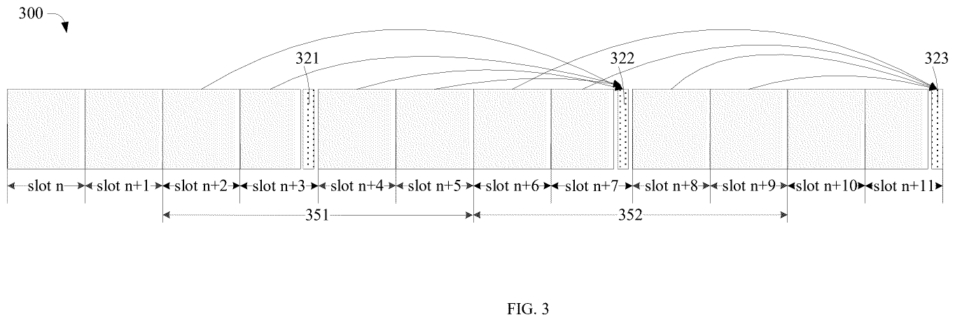

FIG. 3 illustrates an example of HARQ-ACK feedback window according to some embodiments of the present disclosure. It is assumed that the PSFCH periodicity is configured as 4. Based on the PSFCH periodicity, a UE (e.g., a Tx UE or an Rx UE) may determine that slots n+3, n+7, and n+11 include PSFCH transmission occasions 321, 322, and 323, respectively. The UE may further determine that HARQ-ACK feedback corresponding to PSSCHs (if any) in slots n+2 to n+5 can be transmitted in PSFCH transmission occasion 322, and HARQ-ACK feedback corresponding to PSSCHs (if any) in slots n+6 to n+9 can be transmitted in PSFCH transmission occasion 323, based on, for example, the processing delay of the UE being 2 slots. The UE may then determine that HARQ-ACK feedback window 351 includes slots n+2 to n+5 and HARQ-ACK feedback window 352 includes slots n+6 to n+9.

For example, in some embodiments of the present disclosure, a HARQ-ACK feedback window may include one or multiple consecutive or non-consecutive slots within the same COT. The PSFCH transmission occasion may be dynamically indicated by an SCI scheduling a PSSCH with corresponding HARQ-ACK feedback to be transmitted in the PSFCH transmission occasion. One or more slots within a COT where one or more PSSCHs are transmitted and dynamically indicated with the same PSFCH transmission occasion are grouped as a HARQ-ACK feedback window.

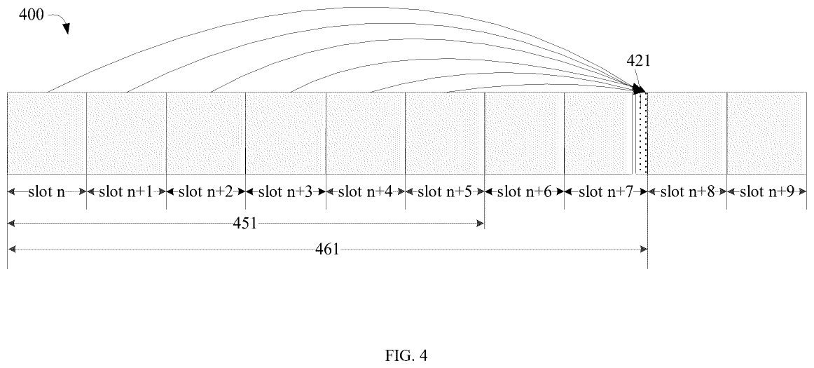

FIG. 4 illustrates an example of HARQ-ACK feedback window according to some embodiments of the present disclosure. A UE (e.g., a Tx UE) may initiate COT 461 by performing a LBT test. The UE may transmit an SCI(s) to schedule PSSCHs in slots n to n+5 and the SCI(s) may indicate PSFCH transmission occasion 421 for transmitting HARQ-ACK feedback for the PSSCHs transmitted in slots n to n+5. The UE may determine that HARQ-ACK feedback window 451 includes slots n to n+5. Another UE (e.g., an Rx UE) which receives the PSSCHs may determine that HARQ-ACK feedback window 451 includes slots n to n+5 based on the indication in the SCI(s).

For example, in some embodiments of the present disclosure, a HARQ-ACK feedback window may include one or multiple consecutive or non-consecutive slots within different COTs. The PSFCH transmission occasion for the HARQ-ACK feedback window may be located inside of a COT and may be dynamically determined based on, for example, an SCI scheduling a PSSCH(s). For those PSSCHs which cannot be responded with HARQ-ACK feedback in the same COT, the corresponding HARQ-ACK feedback may be suspended and triggered by, for example, another SCI in a subsequent COT for transmitting the suspended HARQ-ACK feedback in a PSFCH occasion inside of the subsequent COT. In that sense, the HARQ-ACK feedback window may include multiple slots within different COTs (e.g., the current COT and the subsequent COT).

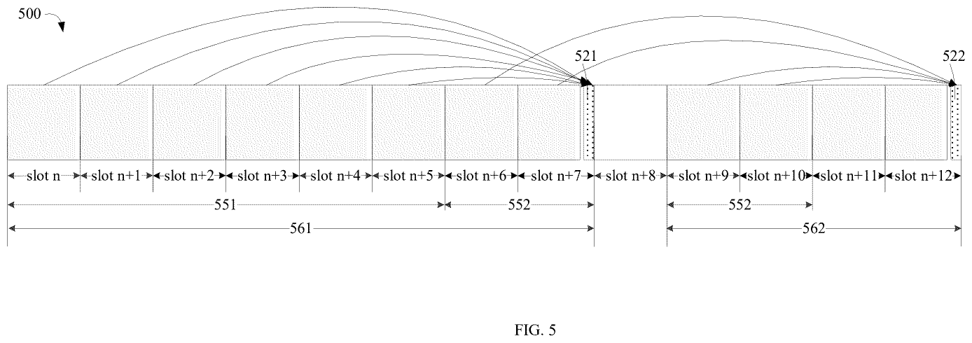

FIG. 5 illustrates an example of HARQ-ACK feedback window according to some embodiments of the present disclosure.

A UE (e.g., a Tx UE) may initiate COT 561 by performing a LBT test. The UE may transmit SCIs to schedule PSSCHs in slots n to n+7. For example, one or more SCIs may schedule PSSCHs in slots n to n+5. In some embodiments, the one or more SCIs may indicate PSFCH transmission occasion 521 for transmitting HARQ-ACK feedback for the PSSCHs transmitted in slots n to n+5. At least one other SCI may schedule PSSCHs in slots n+6 and n+7. Due to the processing delay, HARQ-ACK feedback for the PSSCHs in slots n+6 and n+7 cannot be transmitted in COT 561 and thus is suspended or postponed.

In this scenario, the UE may determine that HARQ-ACK feedback window 551 includes slots n to n+5. Similarly, another UE (e.g., an Rx UE) which receives the PSSCHs in slots n to n+5 may determine that HARQ-ACK feedback window 551 includes slots n to n+5 based on the indication in the one or more SCIs.

In some embodiments, the UE may initiate COT 562. The UE may transmit an SCI(s) to schedule PSSCHs in slots n+9 and n+10. The SCI(s) may indicate PSFCH transmission occasion 522 for transmitting HARQ-ACK feedback for the PSSCHs transmitted in slots n+9 and n+10. In some embodiments, the SCI(s) may trigger the transmission of the HARQ-ACK feedback for the PSSCHs transmitted in n+6 and n+7.

In this scenario, the UE may determine that HARQ-ACK feedback window 552 includes slots n+6 and n+7 and slots n+9 and n+10. Similarly, another UE (e.g., an Rx UE) may determine that HARQ-ACK feedback window 552 includes slots n+6 and n+7 and slots n+9 and n+10.

It should be noted that the above methods for indicating the PSFCH transmission occasion (e.g., dynamically indicated by an SCI), postponing HARQ-ACK feedback transmission, triggering HARQ-ACK feedback transmission are only for illustrative purposes, and other methods can be employed. The method for determining the HARQ-ACK feedback window can also be applied to these methods.

A PSFCH transmission occasion may include a plurality of PSFCH resources (e.g., a PSFCH resource pool). As stated above, a carrier may include a plurality of interlaces. In some embodiments, each interlace of the plurality of interlaces in each of the slots within a HARQ-ACK feedback window may be mapped to one of the plurality of PSFCH resources. Various methods may be employed to implement the above mapping.

In some embodiments of the present disclosure, the number of the plurality of PSFCH resources may be based on the number of the plurality of interlaces and the number of cyclic shift (CS) pairs associated with the plurality of interlaces. In some embodiments, the number of the plurality of PSFCH resources may be equal to the multiplication of the number of the plurality of interlaces and the number of the CS pairs. In some embodiments, the number of slots in a HARQ-ACK feedback window may be smaller than or equal to the number of supported CS pairs. In some embodiments, the supported number of CS pairs can be 1, 2, 3 or 6.

For example, in some embodiments of the present disclosure, the mapping may be based on an {interlace, slot}-pair, wherein the interlace in the pair refers to the index of an interlace of the plurality of interlaces and the slot in the pair refers to the index of a slot within the HARQ-ACK feedback window. For example, assuming that there are M interlaces on the channel or carrier in the frequency domain and there are N slots in the HARQ-ACK feedback window, denoting n the slot index (e.g., slot index with respect to the window) among the N slots and m the interlace index among the M interlaces, thus 0<=n<=N−1, 0<=m<=M−1, for a given PSSCH transmitted on interlace m and in slot n, the associated {interlace, slot}-pair can be expressed as {m, n}. There are several embodiments to determine the corresponding PSFCH resource based on the {interlace, slot}-pair.

For example, in some embodiments of the present disclosure, the mapping may be based on an interlace first and time second manner (also referred to as frequency first and time second manner).

For instance, a PSFCH resource pool may be defined based on the interlace resources and CS pair resources, and each PSFCH resource may have associated resource index within the PSFCH resource pool. The corresponding PSFCH resource index for a given PSSCH transmitted on interlace m in slot n can be expressed by

$${k}_{n}^{m} = n * M + m$$

where,

$${k}_{n}^{m}$$

refers to the PSFCH resource index for one PSFCH resource within the PSFCH resource pool. The PSFCH resource allocation starts in a predefined (e.g., ascending or descending) order of m and continues in a predefined (e.g., ascending or descending) order of n. The PSFCH resource mapping is thus in an order of interlace first and time second.

FIG. 6 illustrates an example of PSFCH resource mapping according to some embodiments of the present disclosure.

In FIG. 6, it is assumed that the 30 kHz SCS is adopted for the channel or carrier and there are total 5 interlaces, which are indexed from 0 to 4 along the “f” axis (e.g., frequency domain) in FIG. 6. It is further assumed that a HARQ-ACK feedback window includes 4 slots, which are indexed from 0 to 3 along the “t” axis (e.g., time domain) in FIG. 6. Then, 20 {interlace, slot}-pairs can be determined and are shown as the 20 time-frequency blocks in FIG. 6.

The 20 {interlace, slot}-pairs may be mapped to 20 PSFCH resources. In some examples, 4 CS pairs may be used for each interlace, then the PSFCH resource pool may include 4×5=20 PSFCH resources, which may be indexed from 0 to 19. The 20 {interlace, slot}-pairs may be mapped to the 20 PSFCH resources in an interlace first and time second manner. For example, as shown in FIG. 6, PSFCH resource index corresponding to each of 20 time-frequency blocks are filled in the corresponding time-frequency blocks in FIG. 6. For example, {interlace, slot}-pairs {0,0}, {1,0}, {2,0}, {3,0}, and {4,0} may be mapped to PSFCH resources 0-4 respectively.

It should be noted that more than 4 CS pairs (e.g., 6 CS pairs) may be used for each interlace, and the PSFCH resource pool may include more than 20 PSFCH resources in this scenario.

For example, in some embodiments of the present disclosure, the mapping may be based on a time first and interlace second manner (also referred to as time first and frequency second manner).

For instance, a PSFCH resource pool may be defined for a PSFCH transmission occasion based on the interlace resources and CS pair resources, and each PSFCH resource may have associated resource index within the PSFCH resource pool. The corresponding PSFCH resource index for a given PSSCH transmitted on interlace m in slot n can be expressed by

$${k}_{n}^{m} = n + m * N$$

where

$${k}_{n}^{m}$$

refers to the PSFCH resource index for one PSFCH resource within the PSFCH resource pool. The PSFCH resource allocation starts in a predefined (e.g., ascending or descending) order of n and continues in a predefined (e.g., ascending or descending) order of m. The PSFCH resource mapping is thus in an order of time first and interlace second.

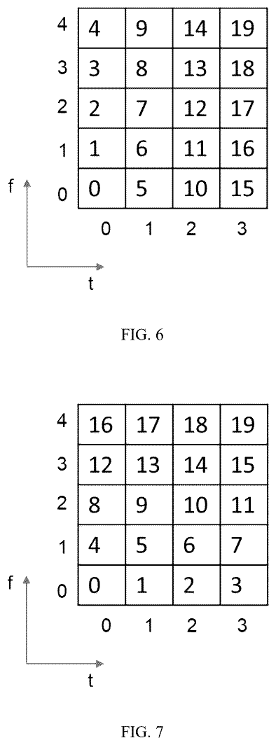

FIG. 7 illustrates an example of PSFCH resource mapping according to some embodiments of the present disclosure.

In FIG. 7, it is assumed that the 30 kHz SCS is adopted for the channel or carrier and there are total 5 interlaces, which are indexed from 0 to 4 along the “f” axis (e.g., frequency domain) in FIG. 7. It is further assumed that a HARQ-ACK feedback window includes 4 slots, which are indexed from 0 to 3 along the “t” axis (e.g., time domain) in FIG. 7. Then, 20 {interlace, slot}-pairs can be determined and are shown as the 20 time-frequency blocks in FIG. 7.

The 20 {interlace, slot}-pairs may be mapped to 20 PSFCH resources. In some examples, 4 CS pairs may be used for each interlace, then the PSFCH resource pool may include 4×5=20 PSFCH resources, which may be indexed from 0 to 19. The 20 {interlace, slot}-pairs may be mapped to the 20 PSFCH resources in a time first and interlace second manner. For example, as shown in FIG. 7, PSFCH resource index corresponding to each of 20 time-frequency blocks are filled in the corresponding time-frequency blocks in FIG. 7. For example, {interlace, slot}-pairs {0,0}, {0,1}, {0,2}, and {0,3} may be mapped to PSFCH resources 0-3 respectively.

It should be noted that more than 4 CS pairs (e.g., 6 CS pairs) may be used for each interlace, and the PSFCH resource pool may include more than 20 PSFCH resources in this scenario.

For example, in some embodiments of the present disclosure, each slot of the slots within the HARQ-ACK feedback window may be associated with a specific CS pair and the mapping may be based on a corresponding interlace and a corresponding CS pair.

For instance, the number of supported CS pairs may be equal to or larger than the number of slots within a HARQ-ACK feedback window. Each CS pair may correspond to one slot of the HARQ-ACK feedback window. For example, CS pair 0 may correspond to slot 0, CS pair 1 may correspond to slot 1, . . . , CS pair n may correspond to slot n, and so on. The corresponding PSFCH resource for an associated {m, n}-pair may be on interlace m and using a CS pair (e.g., CS pair n) corresponding to slot n, and the same CS pair is applied to all RBs of the interlace m.

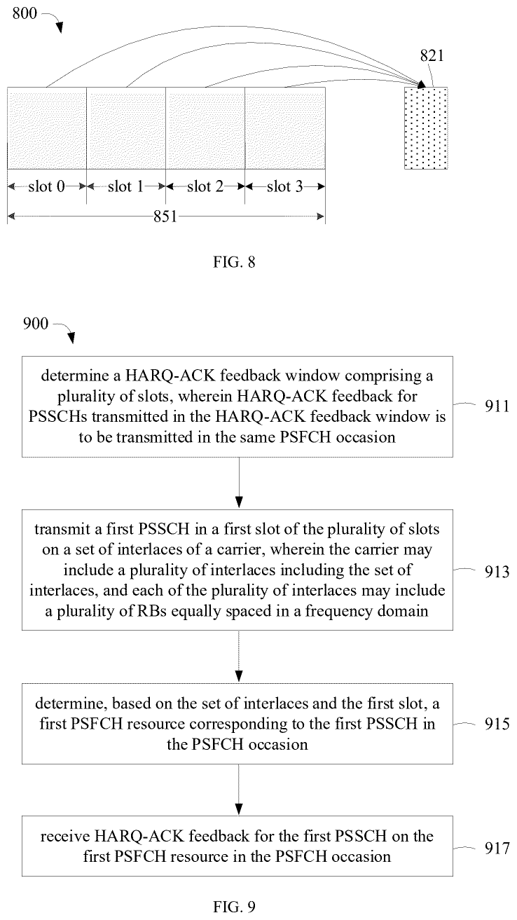

FIG. 8 illustrates an example of PSFCH resource mapping according to some embodiments of the present disclosure.

In FIG. 8, it is assumed that HARQ-ACK feedback window 851 includes 4 slots, which are indexed from 0 to 4 with respect to the HARQ-ACK feedback window, as shown as slots 0 to 4 in FIG. 8. It is further assumed that 4 CS pairs are used for the plurality of interlaces on the carrier. Each of the 4 CS pairs may correspond to one slot of the HARQ-ACK feedback window. For example, CS pair 0 corresponds to slot 0, CS pair 1 corresponds to slot 1, CS pair 2 corresponds to slot 2, and CS pair 3 corresponds to slot 3. Then, for each {m, n}-pair, where m denotes the interlace index, n denotes the slot index in the window, 0<=n<=3, and 0<=m<M−1, the associated PSFCH resource in PSFCH occasion 821 is on interlace m and using a CS pair corresponding to slot n. It should be noted that more than 4 CS pairs (e.g., 6 CS pairs) may be used for each interlace.

In the above embodiments, for multiple PSSCHs using the same interlace in multiple different slots within the same HARQ-ACK feedback window, different CS pairs are applied to the same interlace for the corresponding PSFCH resources. Different PSSCHs in the same slot should be transmitted on different interlaces. In this way, for different PSSCHs in different slots within the same HARQ-ACK feedback window or on different interlaces in the same slot, the HARQ-ACK feedback is transmitted on different PSFCH resources.

According to the above embodiments as shown with respect to FIGS. 6-8, one {interlace, slot}-pair may correspond to one PSFCH resource in the corresponding PSFCH transmission occasion. The number of {interlace, slot}-pairs may be equal to or smaller than the number of PSFCH resources in the corresponding PSFCH transmission occasion, which may be equal to the multiplication of the number of interlaces and the number of CS pairs when the PSFCH is designed based on the interlace and the CS pair as described above.

For example, in the case that the 15 kHz SCS is adopted for the channel or carrier, there are 10 interlaces. Assuming that the maximum number of CS pairs is 6, there are a maximum of 60 PSFCH resources which can correspond to 60 {interlace, slot}-pair and the maximum number of slots within a HARQ-ACK feedback window is 6. In the case that the 30 kHz SCS is adopted for the channel or carrier, there are 5 interlaces. Assuming that the maximum number of CS pairs is 6, there are a maximum of 30 PSFCH resources which can correspond to 30 {interlace, slot}-pair, and the maximum number of slots within a HARQ-ACK feedback window is 6.

A PSSCH may be transmitted on a set of interlaces of the plurality of interlaces of the carrier in a slot within a HARQ-ACK feedback window. In the case that the set of interlace include only a single interlace, a single PSFCH resource for the PSSCH can be determined based on the single interlace and the slot as described above. In the case that the set of interlace include a plurality of interlace, according to the above mapping methods, the set of interlaces in the slot may be mapped to a set of PSFCH resources of the plurality of PSFCH resources in the corresponding PSFCH transmission occasion. Various methods may be employed for determining a PSFCH resource from the plurality of PSFCH resources (e.g., from the set of PSFCH resources) for such PSSCH.

For example, it is assumed that PSSCH #1 is transmitted on a set of interlaces in slot #n within a HARQ-ACK feedback window.

In some embodiments of the present disclosure, the PSFCH resource for PSSCH #1 may be determined based on a predefined interlace (e.g., the lowest or highest in the frequency domain) of the set of interlaces and slot #n. So in these embodiments, there may be one PSFCH resource determined for PSSCH #1.

For example, the lowest interlace among the set of interlaces may be used in the associated {interlace, slot}-pair as described above. For example, referring back to FIG. 6, assuming that PSSCH #1 is transmitted on interlaces 0-4 in slot 0, then the PSFCH resource for PSSCH #1 may be determined based on the pair of {0,0}. That is, PSFCH resource 0 is used for carrying the HARQ-ACK feedback for PSSCH #1.

In some embodiments of the present disclosure, the PSFCH resource for PSSCH #1 may be determined based on all interlaces of the set of interlaces and slot #n. For example, the PSFCH resource for PSSCH #1 may be determined from the set of PSFCH resources corresponding to the set of interlaces in slot #n based on at least a physical layer source ID of the UE transmitting PSSCH #1 or a combination of the physical layer source ID of the UE transmitting PSSCH #1 and a member ID of the UE receiving PSSCH #1. The UE transmitting PSSCH #1 and the UE receiving PSSCH #1 may be in a UE group.

For example, assuming PSSCH #1 is transmitted on z interlaces, e.g., m₀, m₁, . . . , m_{z-1}, 1<=z<=M, (the z interlaces can be contiguous or non-contiguous interlaces in the frequency domain), it thus can be mapped to z PSFCH resources

$${k}_{n}^{{m}_{0}} , {k}_{n}^{{m}_{1}} , … , {k}_{n}^{{m}_{z - 1}} ,$$

according to one of the above mapping method. In some examples, a PSFCH resource index may be further determined from the z PSFCH resources based on the below equation:

K=(P_{ID}+M_{ID})mod z

where, K refers to the PSFCH resource index for one PSFCH resource within the z PSFCH resources

$$( i . e . , {k}_{n}^{{m}_{0}} , {k}_{n}^{{m}_{1}} , {k}_{n}^{{m}_{z - 1}} ) ;$$

P_{ID} refers to a physical layer source ID of the Tx UE (may be provided by an SCI scheduling PSSCH #1); and M_{ID} refers to the identity of the UE receiving PSSCH #1 in a UE group in the case that groupcast ACK or NACK based HARQ-ACK feedback is enabled (e.g., as indicated by the SCI), or otherwise, M_{ID} is zero. In some examples, M_{ID} may be indicated by a higher layer(s) (e.g., RRC layer). In this way, the K^{th} PSFCH resource within the z PSFCH resources is determined for transmitting a PSFCH for PSSCH #1.

FIG. 9 illustrates a flow chart of exemplary procedure 900 for sidelink communications in accordance with some embodiments of the present disclosure. Details described in all of the foregoing embodiments of the present disclosure are applicable for the embodiments shown in FIG. 9. In some examples, the procedure may be performed by a UE, for example, UE 110 in FIG. 1.

Referring to FIG. 9, in operation 911, a first UE may determine a HARQ-ACK feedback window comprising a plurality of slots, wherein HARQ-ACK feedback for PSSCHs transmitted in the HARQ-ACK feedback window is to be transmitted in the same PSFCH occasion. The methods for determining a HARQ-ACK feedback window as described above may apply here.

For example, in some embodiments, the plurality of slots is consecutive slots and the number of the plurality of slots is based on a PSFCH periodicity. In some embodiments, the plurality of slots is consecutive or non-consecutive slots within the same COT. In some embodiments, the plurality of slots is slots within different COTs.

In operation 913, the first UE may transmit a first PSSCH in a first slot of the plurality of slots on a set of interlaces of a carrier, wherein the carrier may include a plurality of interlaces including the set of interlaces, and each of the plurality of interlaces may include a plurality of RBs equally spaced in a frequency domain.

In operation 915, the first UE may determine, based on the set of interlaces and the first slot, a first PSFCH resource corresponding to the first PSSCH in the PSFCH occasion.

In some embodiments, the PSFCH occasion may include a plurality of PSFCH resources. Each interlace of the plurality of interlaces in each slot of the plurality of slots may be mapped to one of the plurality of PSFCH resources. In some embodiments, the number of the plurality of PSFCH resources may be based on the number of the plurality of interlaces and the number of CS pairs associated with the plurality of interlaces. The mapping methods as described above may apply here.

For example, in some embodiments, the mapping is based on an interlace first and time second manner. In some embodiments, the mapping is based on a time first and interlace second manner. In some embodiments, each slot of the plurality of slots is associated with a specific CS pair and the mapping is based on a corresponding interlace and a corresponding CS pair.

In some embodiments, the number of the plurality of slots is smaller than or equal to the number of supported CS pairs.

The methods for determining a PSFCH resource as described above may apply in operation 915.

For example, in some embodiments, determining, based on the set of interlaces and the first slot, the first PSFCH resource corresponding to the first PSSCH may include: determining the first PSFCH resource based on a predefined interlace (e.g., lowest or highest in the frequency domain) of the set of interlaces and the first slot. In some embodiments, determining, based on the set of interlaces and the first slot, the first PSFCH resource corresponding to the first PSSCH may include: determining the first PSFCH resource based on all interlaces of the set of interlaces and the first slot.

In some embodiments, determining the first PSFCH resource based on all interlaces of the set of interlaces and the first slot may include: determining the first PSFCH resource from one or more PSFCH resources corresponding to the set of interlaces in the first slot based on at least a physical layer source ID (e.g., P_{ID}) of the first UE or a combination of the physical layer source ID of the first UE and a member ID (e.g., M_{ID}) of a second UE in a UE group comprising the first UE and the second UE, wherein the second UE receives the first PSSCH.

In operation 917, the first UE may receive HARQ-ACK feedback for the first PSSCH on the first PSFCH resource in the PSFCH occasion.

It should be appreciated by persons skilled in the art that the sequence of the operations in exemplary procedure 900 may be changed and some of the operations in exemplary procedure 900 may be eliminated or modified, without departing from the spirit and scope of the disclosure.

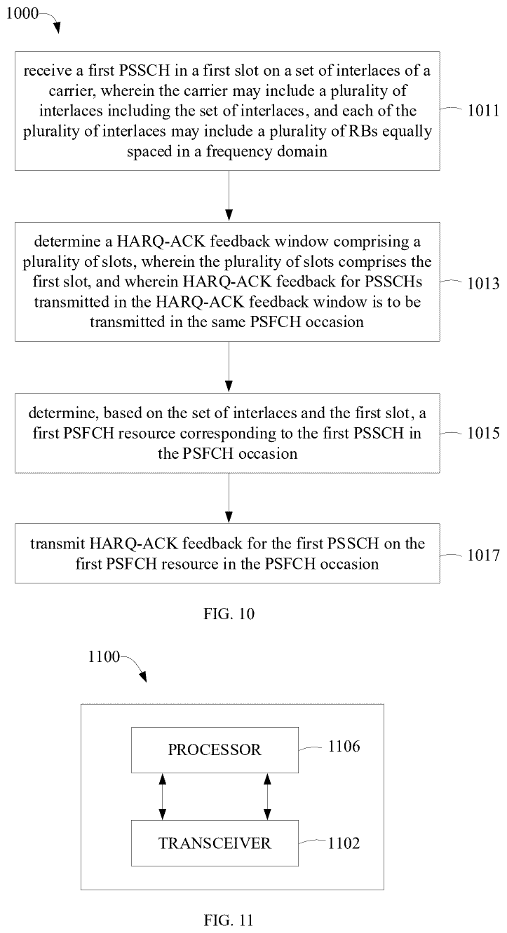

FIG. 10 illustrates a flow chart of exemplary procedure 1000 for sidelink communications in accordance with some embodiments of the present disclosure. Details described in all of the foregoing embodiments of the present disclosure are applicable for the embodiments shown in FIG. 10. In some examples, the procedure may be performed by a UE, for example, UE 110 in FIG. 1.

Referring to FIG. 10, in operation 1011, a second UE may receive a first PSSCH in a first slot on a set of interlaces of a carrier, wherein the carrier may include a plurality of interlaces including the set of interlaces, and each of the plurality of interlaces may include a plurality of RBs equally spaced in a frequency domain.

In operation 1013, the second UE may determine a HARQ-ACK feedback window comprising a plurality of slots, wherein the plurality of slots comprises the first slot, and wherein HARQ-ACK feedback for PSSCHs transmitted in the HARQ-ACK feedback window is to be transmitted in the same PSFCH occasion. The methods for determining a HARQ-ACK feedback window as described above may apply here.

For example, in some embodiments, the plurality of slots is consecutive slots and the number of the plurality of slots is based on a PSFCH periodicity. In some embodiments, the plurality of slots is consecutive or non-consecutive slots within the same COT. In some embodiments, the plurality of slots is slots within different COTs.

In operation 1015, the second UE may determine, based on the set of interlaces and the first slot, a first PSFCH resource corresponding to the first PSSCH in the PSFCH occasion.

In some embodiments, the PSFCH occasion may include a plurality of PSFCH resources. Each interlace of the plurality of interlaces in each slot of the plurality of slots may be mapped to one of the plurality of PSFCH resources. In some embodiments, the number of the plurality of PSFCH resources may be based on the number of the plurality of interlaces and the number of CS pairs associated with the plurality of interlaces. The mapping methods as described above may apply here.

For example, in some embodiments, the mapping is based on an interlace first and time second manner. In some embodiments, the mapping is based on a time first and interlace second manner. In some embodiments, each slot of the plurality of slots is associated with a specific CS pair and the mapping is based on a corresponding interlace and a corresponding CS pair.

In some embodiments, the number of the plurality of slots is smaller than or equal to the number of supported CS pairs.

The methods for determining a PSFCH resource as described above may apply in operation 1015.

For example, in some embodiments, determining, based on the set of interlaces and the first slot, the first PSFCH resource corresponding to the first PSSCH may include: determining the first PSFCH resource based on a predefined interlace (e.g., lowest or highest in the frequency domain) of the set of interlaces and the first slot. In some embodiments, determining, based on the set of interlaces and the first slot, the first PSFCH resource corresponding to the first PSSCH may include: determining the first PSFCH resource based on all interlaces of the set of interlaces and the first slot.

In some embodiments, determining the first PSFCH resource based on all interlaces of the set of interlaces and the first slot may include: determining the first PSFCH resource from one or more PSFCH resources corresponding to the set of interlaces in the first slot based on at least a physical layer source ID (e.g., P_{ID}) of a first UE which transmits the first PSSCH or a combination of the physical layer source ID of the first UE and a member ID (e.g., M_{ID}) of the second UE in a UE group comprising the first UE and the second UE.

In operation 1017, the second UE may transmit HARQ-ACK feedback for the first PSSCH on the first PSFCH resource in the PSFCH occasion.

It should be appreciated by persons skilled in the art that the sequence of the operations in exemplary procedure 1000 may be changed and some of the operations in exemplary procedure 1000 may be eliminated or modified, without departing from the spirit and scope of the disclosure.

FIG. 11 illustrates a block diagram of an exemplary apparatus 1100 according to some embodiments of the present disclosure. As shown in FIG. 11, the apparatus 1100 may include at least one processor 1106 and at least one transceiver 1102 coupled to the processor 1106. The apparatus 1100 may be a UE.

Although in this figure, elements such as the at least one transceiver 1102 and processor 1106 are described in the singular, the plural is contemplated unless a limitation to the singular is explicitly stated. In some embodiments of the present application, the transceiver 1102 may be divided into two devices, such as a receiving circuitry and a transmitting circuitry. In some embodiments of the present application, the apparatus 1100 may further include an input device, a memory, and/or other components.

In some embodiments of the present application, the apparatus 1100 may be a UE. The transceiver 1102 and the processor 1106 may interact with each other so as to perform the operations with respect to the UE described in FIGS. 1-10.

In some embodiments of the present application, the apparatus 1100 may further include at least one non-transitory computer-readable medium. For example, in some embodiments of the present disclosure, the non-transitory computer-readable medium may have stored thereon computer-executable instructions to cause the processor 1106 to implement the method with respect to the UE as described above. For example, the computer-executable instructions, when executed, cause the processor 1106 interacting with transceiver 1102 to perform the operations with respect to the UE described in FIGS. 1-10.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A first user equipment (UE) for wireless communication, comprising:
at least one memory; and
at least one processor coupled with the at least one memory and configured to cause the first UE to:
determine a hybrid automatic repeat request acknowledgement (HARQ-ACK) feedback window comprising a plurality of slots, wherein HARQ-ACK feedback for physical sidelink shared channels (PSSCHs) transmitted in the HARQ-ACK feedback window is to be transmitted in a same physical sidelink feedback channel (PSFCH) occasion;
transmit a first PSSCH in a first slot of the plurality of slots on a set of interlaces of a carrier, wherein the carrier comprises a plurality of interlaces including the set of interlaces, and wherein each of the plurality of interlaces comprises a plurality of resource blocks (RBs) equally spaced in a frequency domain;
determine, based on the set of interlaces and the first slot, a first PSFCH resource corresponding to the first PSSCH in the PSFCH occasion; and
receive HARQ-ACK feedback for the first PSSCH on the first PSFCH resource in the PSFCH occasion.

2. The first UE of claim 1, wherein the plurality of slots are consecutive slots and the number of the plurality of slots is based on a PSFCH periodicity;
wherein the plurality of slots are slots within the same channel occupancy time (COT); or
wherein the plurality of slots are slots within different COTs.

3. The first UE of claim 1, wherein the PSFCH occasion comprises a plurality of PSFCH resources, and each interlace of the plurality of interlaces in each slot of the plurality of slots is mapped to one of the plurality of PSFCH resources.

4. The first UE of claim 3, wherein the number of the plurality of PSFCH resources is based on the number of the plurality of interlaces and a number of cyclic shift (CS) pairs associated with the plurality of interlaces.

5. The first UE of claim 3, wherein the mapping is based on an interlace first and time second manner;
wherein the mapping is based on a time first and interlace second manner; or
wherein each slot of the plurality of slots is associated with a specific cyclic shift (CS) pair and the mapping is based on a corresponding interlace and a corresponding CS pair.

6. The first UE of claim 1, wherein the at least one processor is configured to cause the first UE to determine, based on the set of interlaces and the first slot, the first PSFCH resource corresponding to the first PSSCH, by:
determining the first PSFCH resource based on a predefined interlace of the set of interlaces and the first slot; or
determining the first PSFCH resource based on all interlaces of the set of interlaces and the first slot.

7. The first UE of claim 6, wherein the at least one processor is configured to cause the first UE to determine the first PSFCH resource based on all interlaces of the set of interlaces and the first slot, by:
determining the first PSFCH resource from one or more PSFCH resources corresponding to the set of interlaces in the first slot based on at least a physical layer source ID of the first UE or a combination of the physical layer source ID of the first UE and a member ID of a second UE in a UE group comprising the first UE and the second UE, wherein the second UE receives the first PSSCH.

8. A second user equipment (UE) for wireless communication, comprising:
at least one memory; and
at least one processor coupled with the at least one memory and configured to cause the second UE to:
receive a first physical sidelink shared channel (PSSCH) in a first slot on a set of interlaces of a carrier, wherein the carrier comprises a plurality of interlaces including the set of interlaces, and each of the plurality of interlaces comprises a plurality of resource blocks (RBs) equally spaced in a frequency domain;
determine a hybrid automatic repeat request acknowledgement (HARQ-ACK) feedback window comprising a plurality of slots, wherein the plurality of slots comprises the first slot, and wherein HARQ-ACK feedback for PSSCHs transmitted in the HARQ-ACK feedback window is to be transmitted in a same physical sidelink feedback channel (PSFCH) occasion;
determine, based on the set of interlaces and the first slot, a first PSFCH resource corresponding to the first PSSCH in the PSFCH occasion; and
transmit HARQ-ACK feedback for the first PSSCH on the first PSFCH resource in the PSFCH occasion.

9. The second UE of claim 8, wherein the plurality of slots are consecutive slots and a number of the plurality of slots is based on a PSFCH periodicity;
wherein the plurality of slots are slots within a same channel occupancy time (COT); or
wherein the plurality of slots are slots within different COTs.

10. The second UE of claim 8, wherein the PSFCH occasion comprises a plurality of PSFCH resources, and each interlace of the plurality of interlaces in each slot of the plurality of slots is mapped to one of the plurality of PSFCH resources.

11. The second UE of claim 10, wherein a number of the plurality of PSFCH resources is based on a number of the plurality of interlaces and a number of cyclic shift (CS) pairs associated with the plurality of interlaces.

12. The second UE of claim 10, wherein the mapping is based on an interlace first and time second manner;
wherein the mapping is based on a time first and interlace second manner; or
wherein each slot of the plurality of slots is associated with a specific cyclic shift (CS) pair and the mapping is based on a corresponding interlace and a corresponding CS pair.

13. The second UE of claim 8, wherein the at least one processor is configured to cause the second UE to determine, based on the set of interlaces and the first slot, the first PSFCH resource corresponding to the first PSSCH, by:
determining the first PSFCH resource based on a predefined interlace of the set of interlaces and the first slot; or
determining the first PSFCH resource based on all interlaces of the set of interlaces and the first slot.

14. The second UE of claim 13, wherein the at least one processor is configured to cause the second UE to determine the first PSFCH resource based on all interlaces of the set of interlaces and the first slot, by:
determining the first PSFCH resource from one or more PSFCH resources corresponding to the set of interlaces in the first slot based on at least a physical layer source ID of a first UE which transmits the first PSSCH or a combination of the physical layer source ID of the first UE and a member ID of the second UE in a UE group comprising the first UE and the second UE.

15. A method performed by a first user equipment (UE), the method comprising:
determining a hybrid automatic repeat request acknowledgement (HARQ-ACK) feedback window comprising a plurality of slots, wherein HARQ-ACK feedback for physical sidelink shared channels (PSSCHs) transmitted in the HARQ-ACK feedback window is to be transmitted in the same physical sidelink feedback channel (PSFCH) occasion;
transmitting a first PSSCH in a first slot of the plurality of slots on a set of interlaces of a carrier, wherein the carrier comprises a plurality of interlaces including the set of interlaces, and each of the plurality of interlaces comprises a plurality of resource blocks (RBs) equally spaced in a frequency domain;
determining, based on the set of interlaces and the first slot, a first PSFCH resource corresponding to the first PSSCH in the PSFCH occasion; and
receiving HARQ-ACK feedback for the first PSSCH on the first PSFCH resource in the PSFCH occasion.

16. A processor for wireless communication, comprising:
at least one controller coupled with at least one memory and configured to cause the processor to:
determine a hybrid automatic repeat request acknowledgement (HARQ-ACK) feedback window comprising a plurality of slots, wherein HARQ-ACK feedback for physical sidelink shared channels (PSSCHs) transmitted in the HARQ-ACK feedback window is to be transmitted in a same physical sidelink feedback channel (PSFCH) occasion;
transmit a first PSSCH in a first slot of the plurality of slots on a set of interlaces of a carrier, wherein the carrier comprises a plurality of interlaces including the set of interlaces, and wherein each of the plurality of interlaces comprises a plurality of resource blocks (RBs) equally spaced in a frequency domain;
determine, based on the set of interlaces and the first slot, a first PSFCH resource corresponding to the first PSSCH in the PSFCH occasion; and
receive HARQ-ACK feedback for the first PSSCH on the first PSFCH resource in the PSFCH occasion.

17. The processor of claim 16, wherein the plurality of slots are consecutive slots and the number of the plurality of slots is based on a PSFCH periodicity;
wherein the plurality of slots are slots within the same channel occupancy time (COT); or
wherein the plurality of slots are slots within different COTs.

18. The processor of claim 16, wherein the PSFCH occasion comprises a plurality of PSFCH resources, and each interlace of the plurality of interlaces in each slot of the plurality of slots is mapped to one of the plurality of PSFCH resources.

19. The processor of claim 18, wherein the number of the plurality of PSFCH resources is based on the number of the plurality of interlaces and a number of cyclic shift (CS) pairs associated with the plurality of interlaces.

20. The processor of claim 18, wherein the mapping is based on an interlace first and time second manner;
wherein the mapping is based on a time first and interlace second manner; or
wherein each slot of the plurality of slots is associated with a specific cyclic shift (CS) pair and the mapping is based on a corresponding interlace and a corresponding CS pair.
